(19) United States
(12) Patent Application Publication
(10) Pub. No.: US 2016/0147965 A1
(43) Pub. Date: May 26, 2016

(54) MEDICAL SYSTEM

(71) Applicant: NIHON KOHDEN CORPORATION, Tokyo (JP)

(72) Inventors: Fumiyuki Matsumura, Tokyo (JP); Aoi Ozaki, Tokyo (JP); Shuhei Morinaga, Tokyo (JP)

(21) Appl. No.: 14/945,776

(22) Filed: Nov. 19, 2015

(30) Foreign Application Priority Data
Nov. 21, 2014 (JP) 2014-236950

(51) Int. Cl. G06F 19/00

(52) U.S. Cl. CPC G06F 19/3406; G06F 19/327; G06F 19/3431

(57) ABSTRACT

A medical system includes a transmitter that is attached to a patient to obtain vital sign of the patient, and transmits the vital sign together with position information on a position of the transmitter, and a plurality of portable terminals each of which is carried by a medical staff and displays a position and a condition of the patient based on the position information and the vital sign transmitted from the transmitter. Each of the portable terminals includes an accepting section accepting an operation of showing that the medical staff carrying the portable terminal is coming to the position of the patient, and a transmitting section that transmits, to the portable terminals other than the portable terminal accepting the operation, information corresponding to acceptance of the operation when the operation is accepted by the accepting section.

### CROSS REFERENCE TO RELATED APPLICATION

This application is based on Japanese Patent Applications No. 2014-236950 filed on Nov. 21, 2014, the contents of which are incorporated herein by reference.

### BACKGROUND

The presently disclosed subject matter relates to a medical system.

There are a variety of known techniques for monitoring conditions of patients in a hospital. As one of these techniques, a transmitter is attached to a patient so that the condition of the patient can be measured by the transmitter and transmitted to a display device. The condition of the patient is displayed in the display device, and a medical staff such as a nurse can monitor the condition of the patient from a place away from the patient, such as a nurse station.

In recent years, a technique by which not only the vital sign of a patient but also the position information of the patient is transmitted from a transmitter so as to monitor the position of the patient in a display device is also known (see, for example, JP-A-2012-011176). According to this technique, even when a patient is in a place different from a patient room such as a toilet, if the condition of the patient becomes abnormal, a medical staff can grasp the position of the patient having the abnormal condition and come to the place where the patient is. Besides, from the viewpoint that information can be easily accessed, it has been proposed that the display device is made portable to be carried by every medical staff. Thus, even if a medical staff is, for example, out of the nurse station for purpose of taking care of a patient in a patient room or the like, he/she can monitor the condition of another patient.

However, if a plurality of medical staffs each carrying the above-described display device are in different places out of the nurse station, it is apprehended that the respective medical staffs cannot appropriately cooperate with one another to make useless responses at the occurrence of an alarm. For example, after an alarm generation, although one medical staff has already come to a patient causing the alarm and has started care, another medical staff may redundantly come to the patient.

The presently disclosed subject matter was accomplished in consideration of the above-described circumstances, and an object is to provide a medical system by which a plurality of medical staffs in different places can appropriately cooperate with one another to take care of a patient.

### SUMMARY

A medical system includes a transmitter that is attached to a patient to obtain vital sign of the patient, and transmits the vital sign together with position information on a position of the transmitter, and a plurality of portable terminals each of which is carried by a medical staff and displays a position and a condition of the patient based on the position information and the vital sign transmitted from the transmitter. Each of the portable terminals includes an accepting section accepting an operation of showing that the medical staff carrying the portable terminal is coming to the position of the patient, and a transmitting section that transmits, to the portable terminals other than the portable terminal accepting the operation, information corresponding to acceptance of the operation when the operation is accepted by the accepting section.

### BRIEF DESCRIPTION OF DRAWINGS

FIG. 1 is a diagram illustrating the schematic structure of a medical system according to a first embodiment.

FIG. 2 is a block diagram illustrating the schematic configuration of a portable terminal.

FIG. 3 is a block diagram illustrating functions of the portable terminal.

FIG. 4 is a diagram illustrating an exemplified hardware configuration of the portable terminal.

FIG. 5 is a sequence diagram illustrating procedures in processing performed in the medical system of the first embodiment.

FIG. 6 is a diagram illustrating an example of a screen displayed in the portable terminal in the procedure of step S102 of FIG. 5.

FIG. 7 is a diagram illustrating an example of a screen displayed in the portable terminal in the procedure of step S105 of FIG. 5.

FIG. 8 is a diagram illustrating an example of a screen displayed in the portable terminal in the procedure of step S108 of FIG. 5.

FIG. 9 is a diagram illustrating a state where a medical staff performs care for a patient by using a channel receiving function of the portable terminal.

FIG. 10 is a diagram illustrating a state where a medical staff takes care of a patient having an increasing risk of falling.

FIG. 11 is a diagram for explaining a monitor displaying function of the portable terminal.

FIG. 12 is a diagram illustrating the schematic structure of a wristband type portable terminal.

FIG. 13 is a diagram illustrating the schematic structure of an eyeglass type portable terminal.

FIG. 14 is a diagram illustrating the schematic structure of a medical system according to a second embodiment.

FIG. 15 is a diagram illustrating the schematic structure of a medical system according to a third embodiment.

### DETAILED DESCRIPTION OF EMBODIMENTS

Preferred embodiments of the presently disclosed subject matter will now be described with reference to the accompanying drawings. It is noted that like reference numerals are used to refer to like elements in describing the drawings for omitting redundant description. Besides, dimension ratios employed in the drawings are exaggerated for sake of description and may be different from the actual ratios.

### First Embodiment

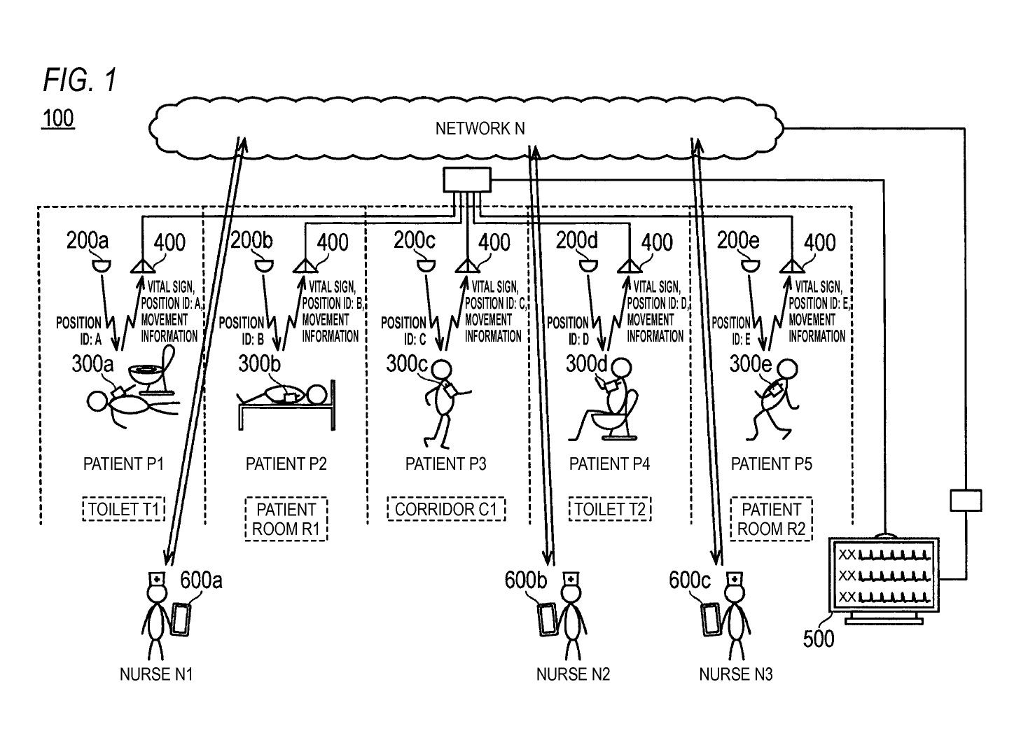

FIG. 1 is a diagram illustrating the schematic structure of a medical system according to a first embodiment.

The medical system of the first embodiment is installed in, for example, a hospital.

As illustrated in FIG. 1, the medical system 100 can include identification information transmitters 200 (200a, 200b, 200c, 200d and 200e), transmitters 300 (300a, 300b, 300c, 300d and 300e), antennas 400, a receiver monitor 500, and portable terminals 600 (600a, 600b and 600c). The respective elements will now be described.

<Identification Information Transmitter 200>

The identification information transmitters are installed in various places in the hospital such as a patient room, a toilet and a corridor. In each of the identification information transmitters 200, peculiar identification information is set. Each of the identification information transmitters 200 repeatedly transmits its own identification information as a position ID.

In the exemplified structure illustrated in FIG. 1, the identification information transmitters 200a, 200b, 200c, 200d and 200e are respectively installed in a toilet T1, a patient room R1, a corridor C1, a toilet T2 and a patient room R2. In the identification information transmitters 200a, 200b, 200c, 200d and 200e, “A”, “B”, “C”, “D” and “E” are respectively set as their position IDs.

The identification information transmitters 200a, 200b, 200c, 200d and 200e transmit the position IDs set therein in ranges respectively covering regions of the toilet T1, the patient room R1, the corridor C1, the toilet T2 and the patient room R2 illustrated with dotted line frames in FIG. 1. For example, the identification information transmitter 200a transmits the position ID “A” for covering the region of the toilet T1. Accordingly, the position ID “A” transmitted from the identification information transmitter 200a is received in the toilet T1. Similarly, the identification information transmitters 200b, 200c, 200d and 200e respectively transmit the position IDs “B”, “C”, “D” and “E” for covering the regions of the patient room R1, the corridor C1, the toilet T2 and the patient room R2. Accordingly, the position IDs “B”, “C”, “D” and “E” respectively transmitted from the identification information transmitters 200b, 200c, 200d and 200e are respectively received in the patient room R1, the corridor C1, the toilet T2 and the patient room R2.

The timing of each identification information transmitter 200 transmitting its own position ID may be random timing within a prescribed period of, for example, 10 seconds ±3 seconds. Alternatively, it may be periodic timing of, for example, every 10 seconds.

<Transmitter 300>

Each transmitter 300 is a device that can be attached to a patient, detects vital sign corresponding to the condition of the patient and transmits the detected information. Specifically, the transmitter 300 has a measuring section (not shown) including an electrocardiogram electrode, a probe and the like, and detects, by using the measuring section, vital sign of the patient such as an electrocardiogram signal, an oxygen saturation (SpO2), a heart rate, a blood pressure, respiratory rate and a body temperature. The transmitter 300 transmits the detected vital sign by a radio signal.

Besides, the transmitter 300 detects and transmits movement information corresponding to the movement of the patient. Specifically, the transmitter 300 includes an acceleration sensor for detecting its own acceleration, and detects and transmits its own acceleration caused in accordance with the movement of the patient to which the transmitter 300 is attached.

Furthermore, the transmitter 300 obtains and transmits position information corresponding to a position of the patient. Specifically, the transmitter 300 is configured to be able to receive the position ID transmitted from any identification information transmitter 200. If the position ID is received, the transmitter 300 transmits the received position ID as the position information of the patient. If the transmitter 300 receives a plurality of position IDs from a plurality of identification information transmitters 200, it may transmit the received plural position IDs. Alternatively, the transmitter 300 may transmit merely a position ID received last in a receiving cycle time of, for example, 10 seconds. Alternatively, the transmitter 300 may transmit a position ID having the highest intensity in receiving among the received plural position IDs.

Different peculiar channels are respectively allocated to the plural transmitters 300 so as to avoid interference among them, and the respective transmitters 300 are identified in accordance with the channels. The channels respectively correspond to, for example, different frequencies.

In the example shown in FIG. 1, the transmitters 300a, 300b, 300c, 300d and 300e are respectively attached to patients P1, P2, P3, P4 and P5. For example, the patient P1 is in the toilet T1, and is in the range covered by the position ID transmitted from the identification information transmitter 200a. Accordingly, the transmitter 300a attached to the patient P1 receives the position ID “A” transmitted from the identification information transmitter 200a. The transmitter 300a transmits the received position ID “A” together with the vital sign and movement information of the patient P1 via the antenna 400 to the receiver monitor 500 by a radio signal. Similarly, the transmitters 300b to 300e respectively attached to the patients P2 to P5 respectively receive the position IDs “B” to “E” transmitted respectively from the identification information transmitters 200b to 200e, and transmit the received position IDs together with the vital sign and operation information of the patients P2 to P5 to the receiver monitor 500.

<Receiver Monitor 500>

The receiver monitor 500 receives the vital sign, the movement information and the position ID transmitted from each transmitter 300, and displays, in a display unit such as a liquid crystal display, the condition, the movement and the position of the patient on the basis of the received information. The receiver monitor 500 stores, in association with the channel used in communication of each transmitter 300, patient information such as the name of the patient to which the transmitter 300 is attached and an alarm generation condition for the patient. Accordingly, when the receiver monitor 500 receives the patient information on the basis of the channel of each transmitter 300 having transmitted the vital sign and the like, it can display the condition, the movement, the position and the like of each patient in association with the patient information of the patient. Besides, the receiver monitor 500 transmits, to the portable terminals 600 through a network N, the information received from each transmitter 300, information generated by analyzing the received information, and the like.

The network N is constructed by a LAN (Local Area Network) formed by connecting computers or network devices to one another in accordance with standards of Ethernet (registered trademark), Wi-Fi (Wireless Fidelity), Zigbee (registered trademark), Bluetooth (registered trademark) or the like. The network N is constructed so that each portable terminal 600 can communicate with the receiver monitor 500 or another portable terminal 600 by wireless. The network N may be a star network in which access points for integrating communications from respective communication terminals are hierarchically provided, or may be a mesh network constructed by respective communication devices mutually communicating.

<Portable Terminal 600>

Each portable terminal 600 is carried or attached by a medical staff, and displays the condition, the movement, the position and the like of a patient. Besides, the portable terminal 600 accepts various operations from the medical staff, and transmits information based on the accepted operations to the receiver monitor 500 or another portable terminal 600 via the network N. Furthermore, the portable terminal 600 automatically obtains the channel of the closest transmitter 300 so that the vital sign and the like can be received from the transmitter 300.

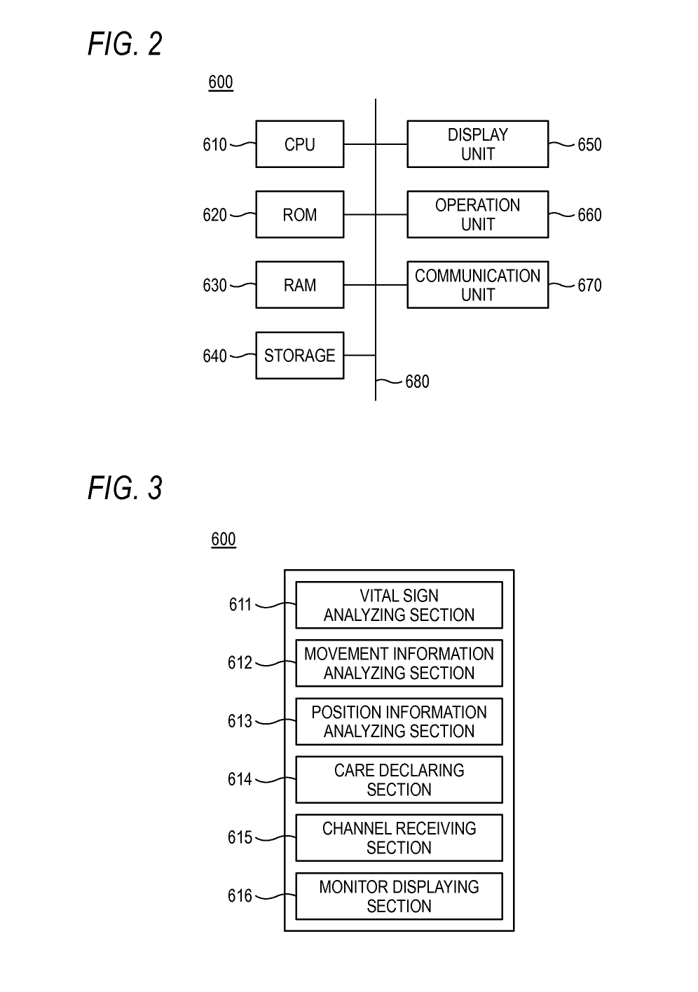

FIG. 2 is a block diagram illustrating the schematic configuration of the portable terminal.

As illustrated in FIG. 2, the portable terminal 600 can include a CPU 610, a ROM 620, a RAM 630, a storage 640, a display unit 650, an operation unit 660 and a communication unit 670, which are mutually connected via a bus 680 for sending/receiving signals.

The CPU 610 controls the respective units and performs various arithmetic processing in accordance with programs stored in the ROM 620 and the storage 640. The CPU 610 functions as an accepting section and a transmitting section by executing the programs. The ROM 620 stores various programs and various data. The RAM 630 temporarily stores a program or data as a working area.

The storage 640 stores various programs including an operating system and various data. Besides, the storage 640 stores, in association with the channel used for the communication by each transmitter 300, the patient information such as the name of a patient to which the transmitter 300 is attached and the alarm generation condition for the patient.

The display unit 650 is, for example, a liquid crystal display, and displays various information such as the name, the condition, the movement, the position and the like of a patient.

The operation unit 660 is used for performing various inputs. The operation unit 660 includes operation keys realized as software of a touch panel system in the display unit 650 or operation buttons or the like provided as hardware.

The communication unit 670 is an interface for communicating with an external device such as the receiver monitor 500. As the interface for communicating with the receiver monitor 500 or another portable terminal 600 via the network N, the standards of, for example, Ethernet (registered trademark), Wi-Fi or Bluetooth (registered trademark) are employed. Besides, the communication unit 670 includes an interface for receiving a radio signal transmitted from each transmitter 300.

Next, the functions of the portable terminal 600 will be described.

FIG. 3 is a block diagram illustrating the functions of the portable terminal.

As illustrated in FIG. 3, the portable terminal 600 functions as a vital sign analyzing section 611, a movement information analyzing section 612, a position information analyzing section 613, a care declaring section 614, a channel receiving section 615 and a monitor displaying section 616. Therefore, the storage 640 stores programs respectively corresponding to the vital sign analyzing section 611, the movement information analyzing section 612, the position information analyzing section 613, the care declaring section 614, the channel receiving section 615, and the monitor displaying section 616. These functions of the portable terminal 600 are exhibited by the CPU 610 executing the corresponding programs.

The vital sign analyzing section 611 analyzes the vital sign of a patient transmitted from the transmitter 300, and displays, in the display unit 650, a graph image, a numerical value or the like corresponding to the condition of the patient. Besides, the vital sign analyzing section 611 determines, by analyzing the vital sign, whether or not the condition of the patient is abnormal, and if it is determined as abnormal, an alarm corresponding to the abnormality is generated. For example, the vital sign analyzing section 611 can detect an abnormality of an arrhythmia or the like by analyzing an electrocardiogram signal transmitted from the transmitter 300.

The movement information analyzing section 612 analyzes the movement information transmitted from the transmitter 300, determines the movement of a patient such as walking or falling, and displays the determined movement in the display unit 650. In the present embodiment, the movement information analyzing section 612 determines the movement of a patient on the basis of acceleration information transmitted from the transmitter 300.

For example, when a patient starts to walk, the transmitter 300 detects, by the acceleration sensor, the acceleration of vertical movement in accordance with a walking cycle, and transmits information corresponding to the detected acceleration as the movement information. Accordingly, if the movement information analyzing section 612 receives the information corresponding to the acceleration from the transmitter 300, it can determine that the patient has started walking. In this case, the movement information analyzing section 612 displays, as the movement of the patient, that the patient is walking in the display unit 650. Here, if a walking state is registered in the storage 640 as the alarm generation condition for the patient having started walking, the movement information analyzing section 612 generates an alarm. In this manner, if a patient that is prohibited to walk or a patient that needs to be assisted in walking starts to walk, a medical staff can immediately grasp this state and perform necessary care.

Besides, when a patient falls down, the acceleration is changed in a moving direction of a strong shock. For example, if a patient falls down, the position of the transmitter 300 is changed in the vertical direction in a state similar to that in free-fall motion. The transmitter 300 usually detects the acceleration in the vertical direction caused by the gravitational acceleration. The gravitational acceleration is, however, cancelled by the free-fall motion caused by the falling of the patient. Therefore, in a moment when the patient falls down, the acceleration in the vertical direction detected by the acceleration sensor of the transmitter 300 is lowered to zero. Accordingly, if the acceleration in the vertical direction received from the transmitter 300 is lowered to zero, the movement information analyzing section 612 can determine that the patient has fallen down. Here, if a falling-down state is registered in the storage 640 as an alarm generation condition for the patient having fallen down, the movement information analyzing section 612 generates an alarm. In this manner, a medical staff can immediately grasp that the patient has fallen down, and perform necessary care.

Incidentally, the movement of the patient is herein determined on the side of the movement information analyzing section 612 with the acceleration information received from the transmitter 300. Instead, with the movement of the patient determined on the side of the transmitter 300, the movement information analyzing section 612 may receive the result of the determination made by the transmitter 300. In this case, there is no need for the movement information analyzing section 612 to determine the movement of the patient based on the acceleration information.

The position information analyzing section 613 specifies, on the basis of the position ID transmitted from the transmitter 300, the position where the patient is, and displays the position in the display unit 650. Specifically, the portable terminal 600 stores, in the storage 640, the position ID transmitted from each identification information transmitter 200 in association with the position where the corresponding identification information transmitter 200 is installed. In the exemplary structure of FIG. 1, the position ID “A”, “B”, “C”, “D” and “E” are in association respectively with the “toilet T1”, the “patient room R1”, the “corridor C1”, the “toilet T2” and the “patient room R2”. Accordingly, if the position ID “A” is received from the transmitter 300a attached to the patient P1, the position information analyzing section 613 can specify the position of the patient P1 as the “toilet T1”.

The care declaring section 614 accepts an operation of declaring that the medical staff is coming to the position of a patient, and transmits information corresponding to this operation to the portable terminals 600 carried by the other medical staffs and the receiver monitor 500. For example, the care declaring section 614 displays, correspondingly to the information of each patient in the display unit 650, a button for declaring that the medical staff carrying the portable terminal 600 is coming to the position of the patient. If the button is pressed by the medical staff, the care declaring section 614 transmits information corresponding to the button operation to the portable terminals 600 carried by the other medical staffs and the receiver monitor 500.

The channel receiving section 615 automatically obtains the channel of the transmitter 300 closest to the portable terminal 600, and receives various information including the vital sign from the transmitter 300. For example, if a prescribed operation of, for example, pressing a button of the operation section 660 is accepted, the channel receiving section 615 receives radio signals with a receiving channel successively switched. The channel receiving section 615 obtains, as the channel of the closest transmitter 300, a channel having the highest intensity of a received radio signal. Here, the intensity of a radio signal attenuates as a distance from the source of the signal (the transmitter 300) is larger. Therefore, if signals have the same intensity in the signal sources of the respective transmitters 300, a signal transmitted by using the channel of the transmitter 300 closest to the portable terminal 600a has the highest signal intensity. Accordingly, if the channel having the highest radio signal intensity is obtained, the channel receiving section 615 can automatically obtain the channel of the closest transmitter 300. The channel receiving section 615 receives the information such as the vital sign from the transmitter 300 by using the obtained channel.

The monitor displaying section 616 works in cooperation with the receiver monitor 500 to display, in the display unit 650, a screen which is the same as or similar to that displayed in the display unit of the receiver monitor 500.

Next, the device configuration of the portable terminal 600 will be described.

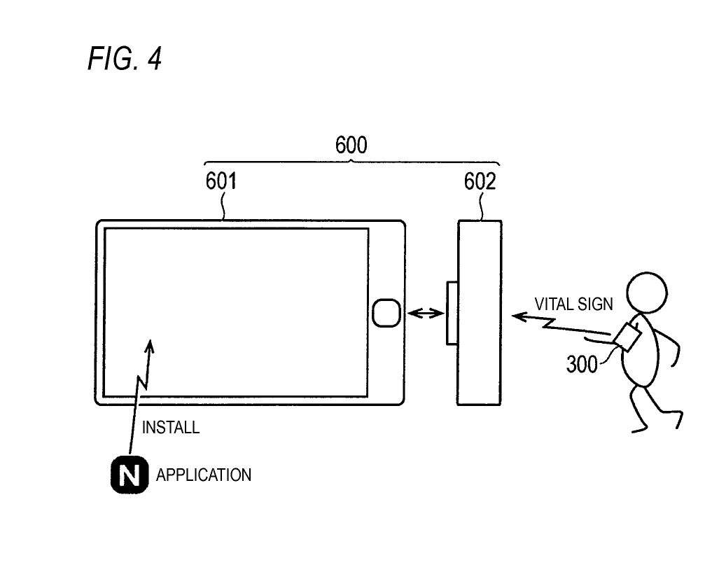

FIG. 4 is a diagram illustrating an example of the hardware configuration of the portable terminal.

As illustrated in FIG. 4, the portable terminal 600 can include a general purpose terminal 601, such as a smartphone or a tablet terminal, and a communication module 602 having a communication function with the transmitter 300. The general purpose terminal 601 and the communication module 602 are connected to each other through an interface connector such as a USB (Universal Serial Bus) or wireless communication by Bluetooth (registered trademark) or the like. “N application” illustrated in FIG. 4 can include the programs corresponding to the vital sign analyzing section 611, the movement information analyzing section 612, the position information analyzing section 613, the care declaring section 614, the channel receiving section 615 and the monitor displaying section 616. When a user such as a medical staff installs the “N application” in the general purpose terminal 601, a control unit of the general purpose terminal 601 executes the “N application” for controlling composing elements of the general purpose terminal 601 and the communication module 602. As a result, the above-described functions of the portable terminal 600 are realized. Since the portable terminal 600 is thus configured, the portable terminal 600 can be realized by utilizing a general purpose terminal, such as a smartphone, originally possessed by a medical staff. Here, pockets of clothes of a medical staff are already occupied by medical test equipment and communication equipment, and hence do not usually have a spare space. Therefore, if the portable terminal 600 is realized by utilizing the existing smartphone or the like as described above, a medical staff can easily carry the portable terminal 600.

Incidentally, the portable terminal 600 may include another composing element in addition to the above-described composing elements, or a part of the above-described composing elements may not be included. Besides, the hardware configuration of the portable terminal 600 is not limited to the configuration including different devices of the general purpose portable terminal 601 and the communication module 602 connected to each other, but the portable terminal 600 may be integrally configured as one device.

<Outline of Processing Performed in Medical System 100>

Next, procedures of processing performed in the medical system 100 of the first embodiment will be described.

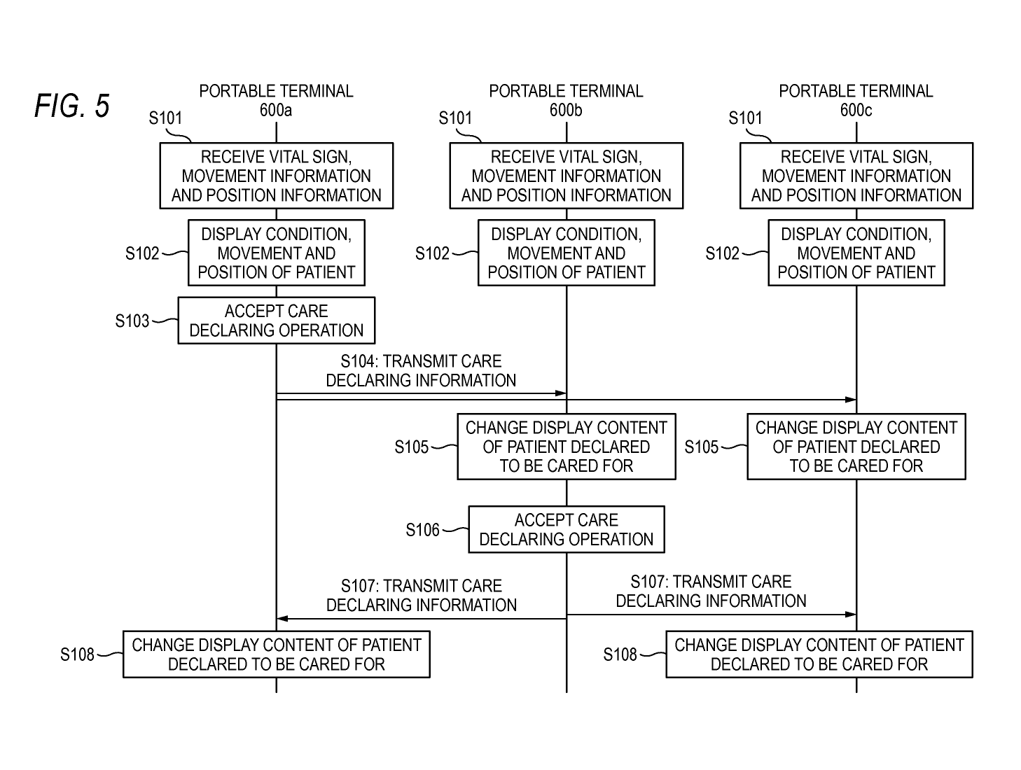

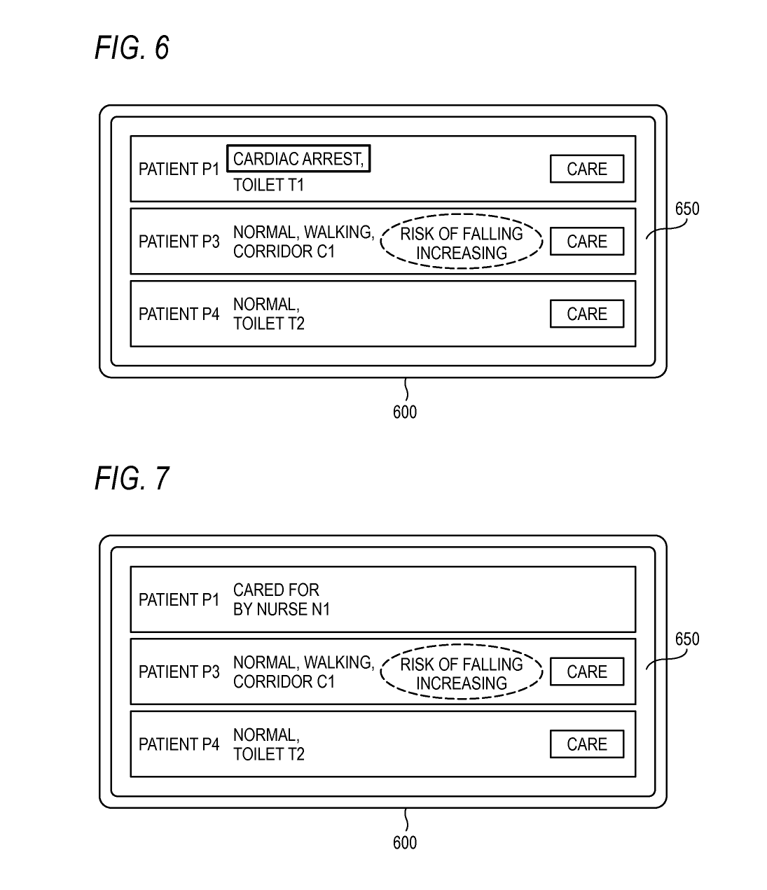

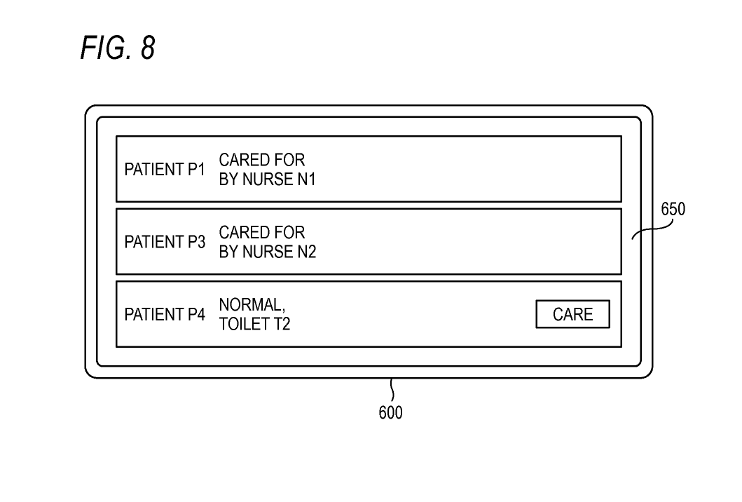

FIG. 5 is a sequence diagram illustrating the procedures of the processing performed in the medical system of the first embodiment. FIG. 6 is a diagram illustrating an example of a screen displayed in the portable terminal 600a in the processing performed in step S102 of FIG. 5. FIG. 7 is a diagram illustrating an example of a screen displayed in the portable terminal 600b in the processing performed in step S105 of FIG. 5. FIG. 8 is a diagram illustrating an example of a screen displayed in the portable terminal 600c in the processing performed in step S108 of FIG. 5. The processing of each portable terminal 600 illustrated in the sequence diagram of FIG. 5 is stored in the storage 640 of the portable terminal 600 as programs, and is executed by the CPU 610 of the portable terminal 600 controlling the respective elements. Besides, the portable terminals 600a, 600b and 600c, the patients P1, P3 and P4, the toilets T1 and T2, the corridor C1 and the like illustrated in FIGS. 5 to 8 respectively correspond to those illustrated in the schematic structure diagram of FIG. 1.

First, the portable terminal 600a receives the vital sign, the movement information and the position information transmitted from the transmitters 300 of the respective patients (step S101). Specifically, the portable terminal 600a receives, by the communication unit 670, the vital sign, the movement information and the position information via the network N. Also the portable terminals 600b and 600c receive the vital sign, the movement information and the position information in the same manner as the portable terminal 600a.

Subsequently, the portable terminal 600a displays the condition and the position of a patient needing care by a medical staff (step S102). Specifically, the portable terminal 600a analyzes the received vital sign and movement information by the vital sign analyzing section 611 and the movement information analyzing section 612, and determines the condition and the movement of each patient. Besides, the portable terminal 600a analyzes the received position information by the position information analyzing section 613, and specifies the position of each patient. Besides, on the basis of the analysis result, the portable terminal 600a determines whether or not each patient needs care by a medical staff. The portable terminal 600a and/or the receiver monitor 500 includes, with respect to each patient, means capable of changing a threshold value used for determining, on the basis of the analysis result of the condition and the movement, whether or not the patient needs care, and if the analysis result exceeds the threshold value, the portable terminal 600a displays the screen as illustrated in FIG. 6 in the display unit 650 for displaying the condition and the position of a patient determined to need care by a medical staff. Also in the portable terminals 600b and 600c, the screen as illustrated in FIG. 6 is displayed in the same manner as in the portable terminal 600a.

In the screen illustrated in FIG. 6, information on the patients P1, P2 and P3 is displayed.

The patient P1 is in a state of cardiac arrest, and is in the toilet T1. The state of cardiac arrest is a state needing immediate care by a medical staff, and therefore, the words “cardiac arrest” are highlighted, and an alarm of generating a warning sound or the like is being generated.

The patient P3 is walking in a normal condition, and is in the corridor C1. Here, it is assumed that the patient P3 has a high risk of falling during a walk. Therefore, an alarm is set to be generated when the patient P3 starts to walk or is walking. Accordingly, in the screen illustrated in FIG. 6, an alarm of “risk of falling increasing” is displayed correspondingly to the patient P3.

The patient P4 is still in a normal condition, and is in the toilet T2. Here, it is assumed that the patient P4 has a risk of falling in a toilet. Therefore, as an alarm setting for the patient P4, if the patient P4 is in a toilet, it is set to be displayed in the portable terminal 600. Accordingly, in the screen of FIG. 6, the information on the patient P4 is displayed.

Subsequently, the portable terminal 600a accepts an operation of declaring that a nurse N1 is coming to the position of the patient P1 (step S103). In the screen of FIG. 6, a “care” button for accepting the operation of declaring that the nurse N1 is coming to the corresponding patient is displayed. In the example shown in FIG. 6, the patient P1 is in the state of cardiac arrest in the toilet T1. Accordingly, the nurse N1 close to the toilet T1 presses the “care” button corresponding to the patient P1 and goes to the toilet T1 for performing care for the patient P1. The care for the patient P1 performed by the nurse N1 will be described later.

Then, the portable terminal 600a transmits, to the portable terminals 600b and 600c, care declaring information that the “care” button corresponding to the patient P1 has been pressed in the portable terminal 600a (step S104). Specifically, the portable terminal 600a transmits the care declaring information to the other portable terminals 600b and 600c via the network N.

When the portable terminals 600b and 600c receive the care declaring information from the portable terminal 600a, the content displayed correspondingly to the patient P1, having been declared to be cared for, is changed (step S105). Specifically, with respect to the patient P1 for whom the “care” button has been pressed by the nurse N1, the portable terminals 600b and 600c change the display content as illustrated in FIG. 7 so that it can be understood that the nurse N1 is already coming to care for him/her. In this manner, nurses N2 and N3 carrying the portable terminals 600b and 600c can be prevented from coming to care for the patient P1 redundantly with the nurse N1.

Here, the screen of FIG. 7 displays that the patient P3 is walking in the corridor C1 and has an increasing risk of falling. Accordingly, the nurse N2 close to the corridor C1 presses the “care” button corresponding to the patient P3 and comes to the corridor C1 to perform care for the patient P3. The care for the patient P3 performed by the nurse N2 will be described later.

As described above, the portable terminal 600b accepts the operation of declaring that the nurse N2 is coming to the position of the patient P3 (step S106).

Subsequently, the portable terminal 600b transmits, to the portable terminal 600c, care declaring information that the “care” button corresponding to the patient P3 has been pressed in the portable terminal 600b (step S107). Here, the portable terminal 600b may transmit the care declaring information also to the portable terminal 600a, which has already accepted the care declaring operation.

When the care declaring information is received from the portable terminal 600b, the portable terminal 600c changes the display content corresponding to the patient P3 having been declared to be cared for (step S108). Specifically, with respect to the patient P3 for whom the “care” button has been pressed by the nurse N2, the portable terminals 600c changes the display content as illustrated in FIG. 8 so that it can be understood that the nurse N2 is already coming to care for him/her. In this manner, the nurse N3 carrying the portable terminal 600c can be prevented from coming to care for the patient P3 redundantly with the nurse N2. As a result, the nurse N3 can, for example, come to the toilet T2 to see how the patient P4 is. Alternatively, the nurse N3 can check the condition of another patient by using a monitor displaying function of the portable terminal 600c. The monitor displaying function of the portable terminal 600 will be described later.

<Example of Care for Patient P1 Performed by Nurse N1>

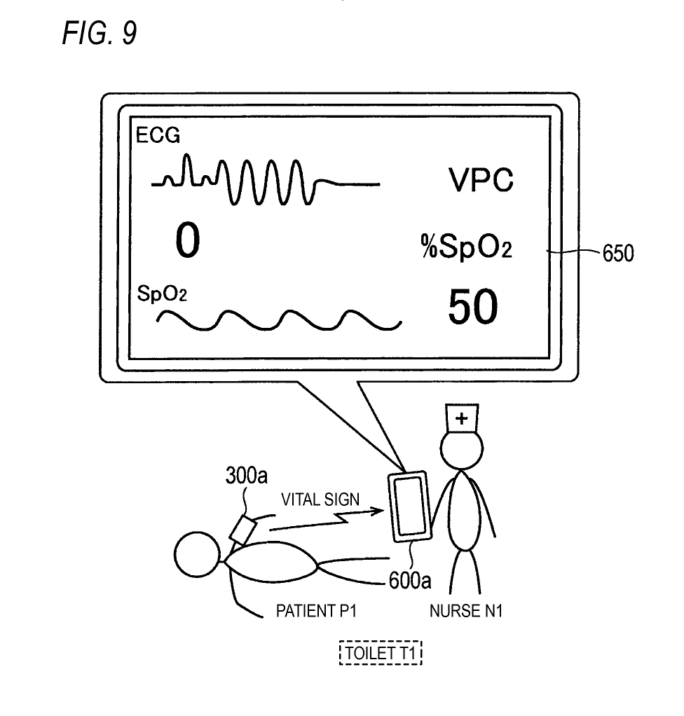

FIG. 9 is a diagram illustrating a state where a medical staff cares for a patient by using the channel receiving function of the portable terminal.

As illustrated in FIG. 9, the nurse N1 having pressed the “care” button corresponding to the Patient P1 in the portable terminal 600a comes to the patient P1 in the toilet T1. In order to check the condition of the patient P1, the nurse N1 brings the portable terminal 600a close to the transmitter 300a of the patient P1. The channel receiving section 615 of the portable terminal 600a obtains the channel used by the transmitter 300a from the transmitter 300a, that is, the closest transmitter 300. The portable terminal 600a receives the vital sign of the patient P1 from the transmitter 300a through the obtained channel. The portable terminal 600a displays, on the basis of the received vital sign, the condition of the patient P1 in the display unit 650. Thus, the portable terminal 600a can display the vital sign directly received from the transmitter 300a without being influenced by transmission delay or a data capacity limit that can be otherwise caused depending on the communication environment in the network N or the like. Accordingly, the nurse N1 can simply and definitely check the vital sign of the patient P1 to perform appropriate care.

<Example of Care for Patient P3 Performed by Nurse N2>

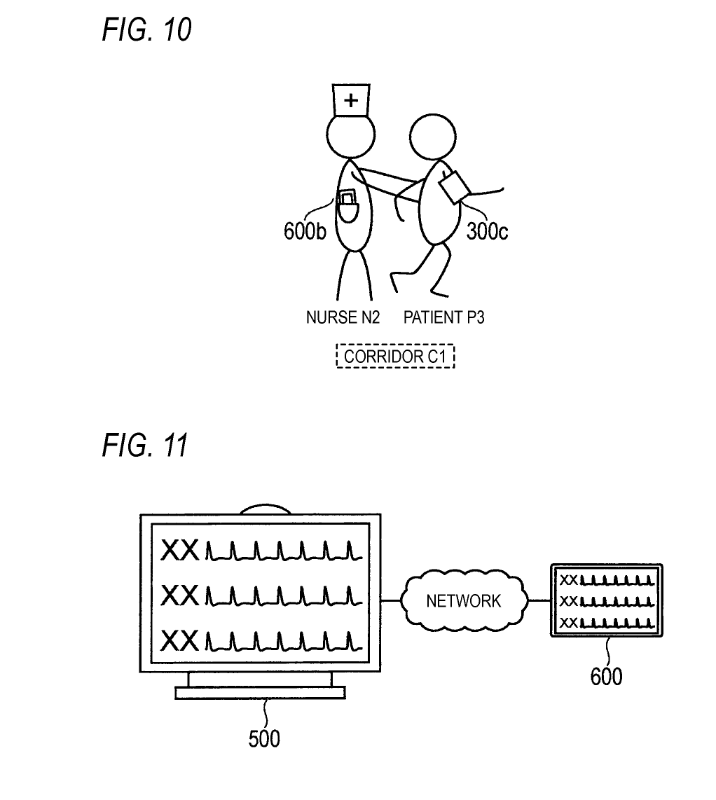

FIG. 10 is a diagram illustrating a state where a medical staff performs care for a patient having an increasing risk of falling.

As illustrated in FIG. 10, the nurse N2 having pressed the “care” button corresponding to the patient P3 in the portable terminal 600b comes to the patient P3 in the corridor C1. The nurse N2 assists the patient P3 so that the patient P3 cannot fall down. In this case, in order to assist the patient P3 with both hands, the nurse N2 needs to put the portable terminal 600b held in hand in a pocket or the like of his/her clothes. Here, the portable terminal 600 of the present embodiment can be realized by using a general purpose terminal such as a smartphone originally possessed by the nurse N2 as described above, and hence the portable terminal 600 does not need its own holding space. Accordingly, the nurse N2 can easily put the portable terminal 600 in a pocket or the like, and can rapidly and definitely assist the patient P3.

<Monitor Displaying Function of Portable Terminal 600>

FIG. 11 is a diagram for describing the monitor displaying function of the portable terminal.

As illustrated in FIG. 11, the portable terminal 600 displays, in the display unit 650, a screen which is the same as or similar to that displayed in the receiver monitor 500. Specifically, the monitor displaying section 616 of the portable terminal 600 communicates with the receiver monitor 500 to obtain various information corresponding to the condition, the movement, the position and the like of each patient displayed in the receiver monitor 500, and displays the obtained information in the display unit 650. As a result, a nurse can easily check the condition and the like of each patient even he/she is in a place such as a patient room out of the nurse station.

As described so far, according to the medical system 100 of the present embodiment, the portable terminal 600 accepts the care declaring operation of showing that a medical staff is coming to a position of a patient, and transmits, to the other portable terminals 600, information corresponding to the acceptance of the care declaring operation. As a result, medical staffs in a variety of places can appropriate cooperate with one another to take care of patients.

Besides, the portable terminal 600 determines a risk of falling of a patient on the basis of at least one of the position information and the movement information of the patient, and if there is a risk of falling, it displays, in association with the position of the patient, a “care” button for accepting a declaration of a medical staff to take care of the patient. As a result, for example, if a patient is walking in haste to a toilet or the like, or if a patient needing to be assisted in a toilet enters a toilet, it is presumed that a patient is in a state having a high risk of falling, so that the patient can be appropriately cared for before falling down.

Incidentally, the transmitter 300 is provided with the acceleration sensor for detecting the falling of a patient by detecting the change of the acceleration in the exemplified case described in the present embodiment. The method for detecting the falling is, however, not limited to this method. For example, the transmitter 300 may be provided with an atmospheric pressure sensor so as to detect the falling of a patient by detecting change of an atmospheric pressure. Since the transmitter 300 is attached to a patient, if the patient falls down from a standing state, the height of the transmitter 300 is abruptly lowered. When the height is lowered, the ambient atmospheric pressure is increased. Accordingly, the falling of a patient can be detected by detecting an abrupt increase of the atmospheric pressure by the atmospheric pressure sensor. Alternatively, the transmitter 300 may be provided with an angular velocity sensor so as to detect the falling of a patient by detecting the inclination of the patient, or the falling of a patient can be detected by combining detection results of a plurality of sensors described above.

Besides, the portable terminal 600 performs the vital sign analysis, the movement information analysis and the position information analysis in the above-described embodiment, which does not limit the presently disclosed subject matter. These functions of the portable terminal 600 may be realized by another device such as the receiver monitor 500 or the transmitter 300, or may be realized by another equipment such as a server additionally provided in the network.

Furthermore, the portable terminal 600 displays the condition, an alarm and the like of a patient needing care by a medical staff in the screen of FIG. 6 or the like in the above-described embodiment, which does not limit the presently disclosed subject matter. The portable terminal 600 may, for example, always display information of all patients, or selectively display information of a specific patient.

Besides, the portable terminal 600 transmits the care declaring information to the other portable terminals 600 through the network N in the above-described embodiment, which does not limit the presently disclosed subject matter. The portable terminal 600 may transmit the care declaring information once to the receiver monitor 500 so that the receiver monitor 500 can transmit the care declaring information to the other portable terminals. Alternatively, the portable terminal 600 may transmit the care declaring information by directly communicating with the other portable terminals without using the network N.

Furthermore, the portable terminal 600 is held in hand by a medical staff when used in the above-described embodiment, but the form of the portable terminal 600 is not limited to this. Examples of another form of the portable terminal 600 will now be described.

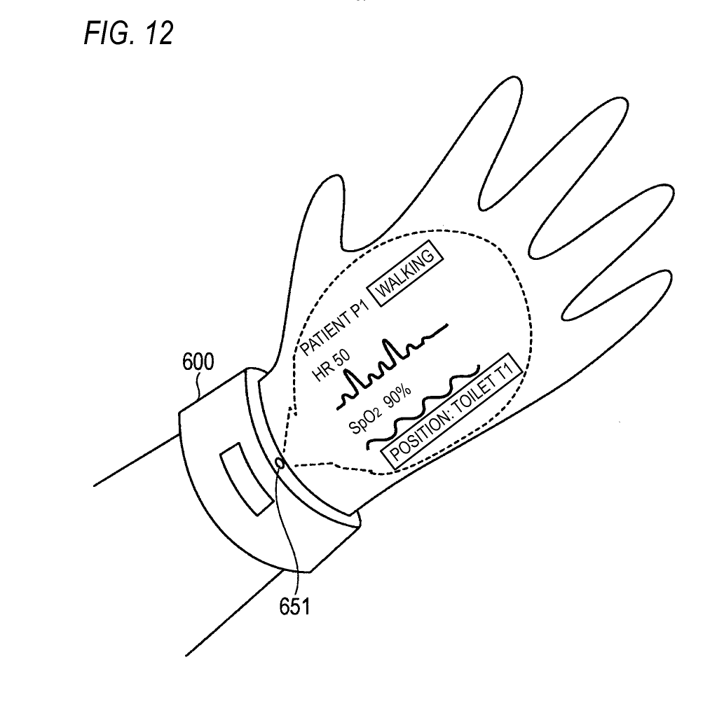

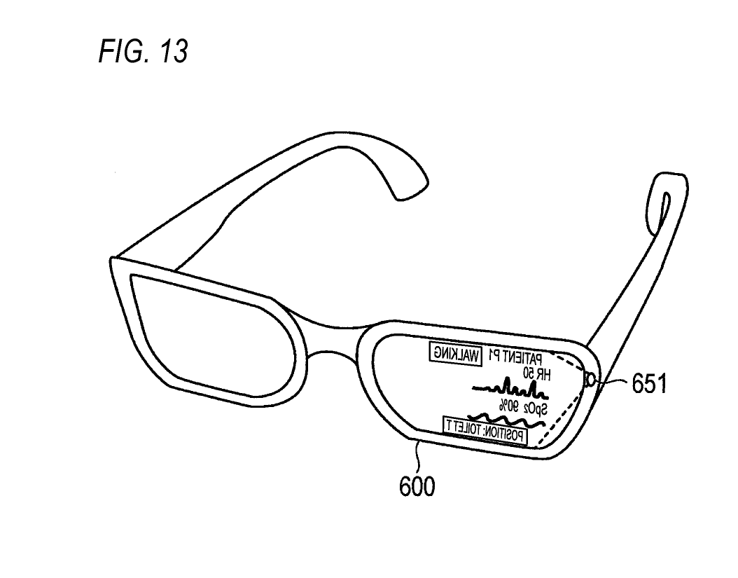

FIG. 12 is a diagram illustrating the schematic structure of a wristband type portable terminal. FIG. 13 is a diagram illustrating the schematic structure of an eyeglass type portable terminal.

As illustrated in FIG. 12, the portable terminal 600 may be configured as a wristband type device. In the exemplified structure of FIG. 12, a projection unit 651 for displaying an image by projecting light onto a screen is provided instead of the display unit 650, so as to display various information of a patient by using the hand of a medical staff as the screen. If the portable terminal 600 is thus configured as the wristband type device, there is no need for a medical staff to hold the portable terminal 600 during use, and hence, he/she can easily perform the work for assisting a patient and the like. Besides, there is no need to put the portable terminal 600 in a pocket of the clothes or the like, and the portable terminal 600 is less left behind. Furthermore, since the display unit 650 of the portable terminal 600 is replaced with the projection unit 651, the portable terminal 600 can attain space saving and weight reduction, and hence the operational efficiency of the medical staff can be improved.

Alternatively, the portable terminal 600 may be configured as an eyeglass type device as illustrated in FIG. 13. In the exemplified structure of FIG. 13, the projection unit 651 is provided in a rim of eyeglasses, so as to display various information of a patient by using an eyeglass portion of the eyeglasses as the screen. If the portable terminal 600 is thus configured as the eyeglass type device, not only the effects attained by employing the wristband type structure can be attained but also the medical staff can check the condition and the like of a patient without taking his/her eyes off the patient while watching the patient, and hence, the operational efficiency of the medical staff can be further improved.

### Second Embodiment

Next, a medical system according to a second embodiment will be described. It is noted that like reference numerals are used to refer to like elements included in the medical system of the first embodiment for omitting the description.

The transmitters 300 perform the communication via the antennas 400 in the first embodiment. Besides, the transmitters 300 obtain position IDs from the identification information transmitters 200 to specify their positions on the basis of the obtained position IDs. The communication method and the method for specifying the positions of the transmitters 300 are, however, not limited to these methods. The transmitters 300 may perform the communication by utilizing the same network as the portable terminals 600, and the positions may be specified by using the network. In the second embodiment, a case where each transmitter 300 performs the communication by utilizing the same network as the portable terminals 600 and the position of the transmitter 300 is specified by using the network will be described.

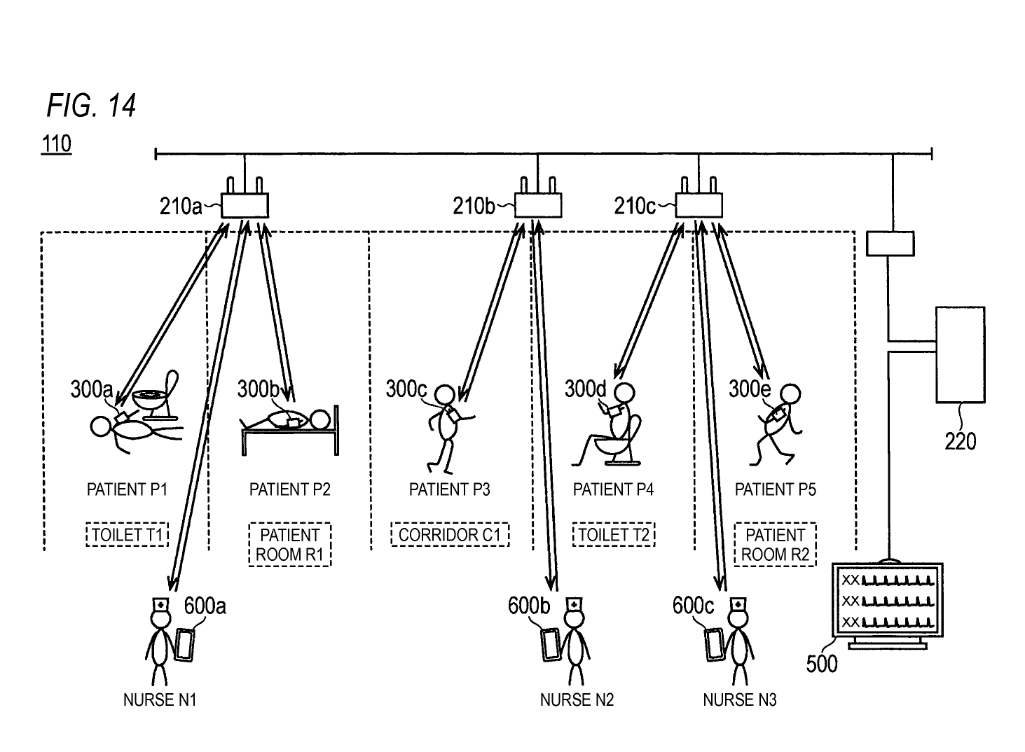

FIG. 14 is a diagram illustrating the schematic structure of the medical system according to the second embodiment.

As illustrated in FIG. 14, the medical system 110 includes access points 210 (210a, 210b and 210c), a server 220, transmitters 300 (300a, 300b, 300c, 300d and 300e), a receiver monitor 500 and portable terminals 600 (600a, 600b and 600c).

Each access point 210 is a wireless LAN router for providing, for example, a wireless connection function in accordance with the Wi-Fi standards or a wired connection function in accordance with Ethernet (registered trademark) standards. Each of the transmitters 300 and the portable terminals 600 can perform wireless communication by receiving and utilizing a radio wave for Wi-Fi connection transmitted from each access point 210.

The server 220 is a computer connected to the access points 210 and the receiver monitor 500 through connection in accordance with Ethernet (registered trademark) standards. The server 220 specifies the position of each transmitter 300 on the basis of position information transmitted from the transmitter 300.

Each transmitter 300 performs wireless communication via the access points 210. The transmitter 300 transmits, in the same manner as in the first embodiment, vital sign and movement information of a patient. Besides, the transmitter 300 transmits, to the server 220 as the position information, signal intensity information corresponding to a signal intensity in receiving a radio wave from each access point 210 and access point information corresponding to information for identifying that access point 210. The access point information is, for example, an SSID (Service Set Identifier), a MAC address (Media Access Control address) or the like. If the transmitter 300 receives radio waves from a plurality of access points 210, the transmitter 300 transmits, to the server 220, signal intensities in receiving the radio waves from the respective access points 210 in association with the information for identifying the respective access points 210.

A storage unit (not shown) of the server 220 stores installation positions of the respective access points 210. Besides, the storage unit of the server 220 precedently stores table information in which the signal intensity obtained by one transmitter 300 in receiving a radio wave sent from each access point 210 and a distance from the access point 210 to the transmitter 300 are in association with each other. Here, the intensity of a radio signal attenuates as a distance from the source of the signal (the access point 210) is larger. Therefore, if the intensity of a radio signal received from a given access point 210 by the transmitter 300 is high, it is understood that the distance between the transmitter 300 and this access point 210 is short. On the other hand, if the intensity of a radio signal received from the access point 210 by the transmitter 300 is low, it is understood that the distance between the transmitter 300 and the access point 210 is long. The information corresponding to the relationship between the signal intensity and the distance determined in accordance with results of calculations and experiments based on the above-described principle is stored as the table information.

The server 220 specifies the position of the transmitter 300 on the basis of the signal intensity information and the access point information transmitted from the transmitter 300 and the table information stored in the storage unit. For example, if the transmitter 300 transmits the signal intensity information and the access point information of one access point 210, the server 220 can specify that the transmitter 300 is in a position at a distance from the installation position of this access point 210. Besides, if the transmitter 300 transmits the signal intensity information and the access point information of a plurality of access points 210, the server 220 can specify distances from the installation positions of the respective access points 210 to the transmitter 300. Thus, the server 220 can precisely specify the position of the transmitter 300.

After specifying the position of the transmitter 300, the server 220 transmits information corresponding to the position of the transmitter 300 to the portable terminals 600.

Each portable terminal 600 receives various information from the server 220, the transmitters 300 or the receiver monitor 500 via the access points 210. The portable terminal 600 can display the condition, the movement, the position and the like of a patient and accept a care declaring operation in the same manner as in the first embodiment.

In this manner, in the medical system 110 of the second embodiment, both the transmitters 300 and the portable terminals 600 perform the communication by utilizing the access points 210, and the position of each transmitter 300 is specified on the basis of the information on the access points 210. Therefore, the medical system 110 can be realized by a simple structure, and the burden of the system architecture, operation and maintenance can be reduced.

Incidentally, the position of each transmitter 300 is specified by the server 220 in the above-described embodiment, which does not limit the presently disclosed subject matter. The position of the transmitter 300 may be specified by, for example, the portable terminal 600 or the receiver monitor 500.

### Third Embodiment

Next, a medical system according to a third embodiment will be described. It is noted that like reference numerals are used to refer to like elements included in the medical system of the first embodiment for omitting the description.

In the first embodiment, the network N used by the portable terminals 600 for performing the wireless communication is provided separately from the identification information transmitters 200. The network used by the portable terminals 600 for performing the wireless communication is not, however, limited to this. The network used by the portable terminals 600 for performing the wireless communication may be constructed by the identification information transmitters. The third embodiment will describe a case where the network used by the portable terminals 600 for performing the communication is constructed by utilizing identification information transmitters.

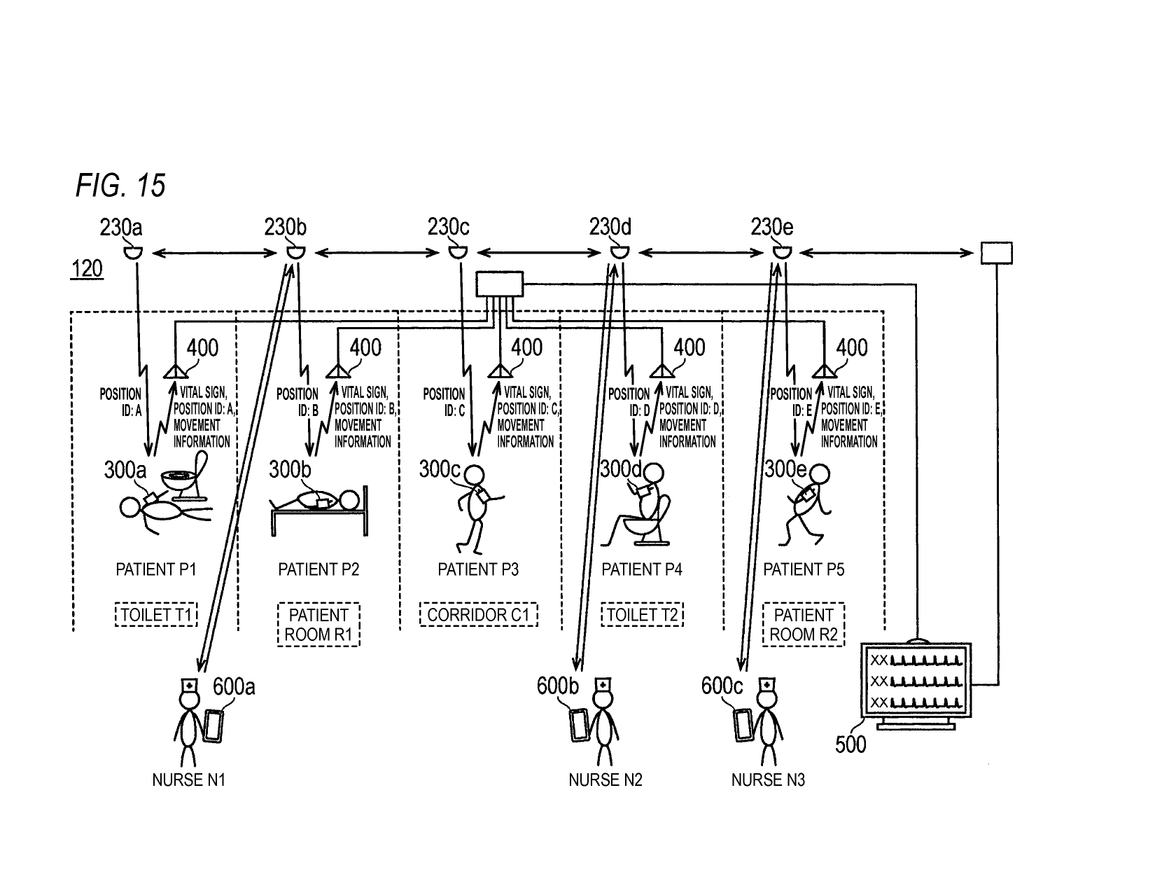

FIG. 15 is a diagram illustrating the schematic structure of the medical system according to the third embodiment.

The medical system 120 includes, as illustrated in FIG. 15, identification information transmitters 230 (230a, 230b, 230c, 230d and 230e), transmitters 300 (300a, 300b, 300c, 300d and 300e), antennas 400, a receiver monitor 500 and portable terminals 600 (600a, 600b and 600c).

The identification information transmitters 230a to 230e respectively transmit position IDs “A” to “E” for specifying the positions of the transmitters 300 in the same manner as in the first embodiment. Besides, the identification information transmitters 230a to 230e are constructed to be capable of communicating with one another to form a mesh network using the identification information transmitters 230a to 230e as communication nodes. Furthermore, the identification information transmitters 230a to 230e are capable of communicating with the portable terminals 600, and the mesh network constructed by the identification information transmitters 230a to 230e is also connected to the receiver monitor 500.

When one portable terminal 600 is connected to the mesh network constructed by the identification information transmitters 230a to 230e, it can perform communication with the receiver monitor 500 or another portable terminal 600. The portable terminal 600 receives various information from the transmitters 300 or the receiver monitor 500 through the mesh network. Each portable terminal 600 can display the condition, the movement, the position and the like of a patient and accept a care declaring operation in the same manner as in the first embodiment.

In this manner, in the medical system 120 of the third embodiment, the mesh network is constructed by the identification information transmitters 230, and the portable terminals 600 perform the wireless communication through the mesh network. Therefore, for example, in a facility where the identification information transmitters 230 and the antennas 400 are already introduced, the medical system 120 can be realized by utilizing the existing equipment without constructing a new network infrastructure.

[1] According to an aspect of the embodiments, a medical system includes a transmitter and a plurality of portable terminals. The transmitter is attached to a patient to obtain vital sign of the patient, and transmits the vital sign together with position information on a position thereof. Each of the plurality of portable terminals is carried by a medical staff and displays a position and a condition of the patient on the basis of the position information and the vital sign transmitted from the transmitter. Each of the portable terminals includes an accepting section accepting an operation of showing that the medical staff carrying the portable terminal is coming to the position of the patient, and a transmitting section that transmits, to the other portable terminals among the plurality of portable terminals, information corresponding to acceptance of the operation when the operation is accepted by the accepting section.

[2] According to another aspect of the embodiments, a medical system includes a transmitter and a plurality of portable terminals. The transmitter is attached to a patient to obtain vital sign of the patient, and transmits the vital sign together with position information on a position thereof and movement information on movement of the patient. Each of the plurality of portable terminals is carried by a medical staff and receives the position information, the movement information and the vital sign transmitted from the transmitter. Each of the portable terminals includes an accepting section that, when it is determined, on the basis of at least one of the position information and the movement information, that the patient has a risk of falling, accepts declaration of caring for the patient in association with a position of the patient.

According to the embodiments, a portable terminal accepts a care declaring operation of showing that a medical staff is coming to a position of a patient, and transmits, to the other portable terminals, information corresponding to acceptance of the care declaring operation. As a result, medical staffs in various places can appropriately cooperate with one another to take care of the patient.

What is claimed is:

1. A medical system, comprising:
a transmitter that is attached to a patient to obtain vital sign of the patient, and transmits the vital sign together with position information on a position of the transmitter; and
a plurality of portable terminals each of which is carried by a medical staff and displays a position and a condition of the patient based on the position information and the vital sign transmitted from the transmitter,
wherein each of the portable terminals includes:
an accepting section accepting an operation of showing that the medical staff carrying the portable terminal is coming to the position of the patient; and
a transmitting section that transmits, to the portable terminals other than the portable terminal accepting the operation, information corresponding to acceptance of the operation when the operation is accepted by the accepting section.

2. A medical system, comprising:
a transmitter that is attached to a patient to obtain vital sign of the patient, and transmits the vital sign together with position information on a position of the transmitter and movement information on movement of the patient; and
a plurality of portable terminals each of which is carried by a medical staff and receives the position information, the movement information and the vital sign transmitted from the transmitter,
wherein each of the portable terminals includes an accepting section that, when it is determined that the patient has a risk of falling based on at least one of the position information and the movement information, accepts declaration of caring for the patient in association with a position of the patient.

3. The medical system according to claim 1, wherein each of the portable terminals is of a wristband type that is attachable to an arm of the medical staff or of an eyeglass type that is wearable on a head of the medical staff.

4. The medical system according to claim 2, wherein each of the portable terminals is of a wristband type that is attachable to an arm of the medical staff or of an eyeglass type that is wearable on a head of the medical staff.

5. The medical system according to claim 1, wherein each of the portable terminals is capable of analyzing the vital sign and determining whether a condition of the patient is normal or abnormal based on a result of analysis of the vital sign.

6. The medical system according to claim 2, wherein each of the portable terminals is capable of analyzing the vital sign and determining whether a condition of the patient is normal or abnormal based on a result of analysis of the vital sign.

7. The medical system according to claim 3, wherein each of the portable terminals is capable of analyzing the vital sign and determining whether a condition of the patient is normal or abnormal based on a result of analysis of the vital sign.

8. The medical system according to claim 2, further comprising a receiver monitor that displays the position, the movement and a condition of the patient based on the position information, the movement information and the vital sign transmitted from the transmitter,
wherein each of the portable terminals or the receiver monitor includes a setting section that sets a threshold value used for determining whether or not the patient needs to be cared for based on the vital sign and the movement information.
